(19) United States
(12) Patent Application Publication
(10) Pub. No.: US 2018/0075308 A1
(43) Pub. Date: Mar. 15, 2018

(54) Methods And Systems For Adaptive On-Demand Infrared Lane Detection

(71) Applicant: GM GLOBAL TECHNOLOGY OPERATIONS LLC, Detroit, MI (US)

(72) Inventors: Xiaofeng F. Song, Novi, MI (US); Valor Yaldo, Farmington Hills, MI (US)

(21) Appl. No.: 15/265,121

(22) Filed: Sep. 14, 2016

(51) Int. Cl. G06K 9/00; G08G 1/16; G06T 7/20

(52) U.S. Cl. CPC G06K 9/00798; G08G 1/167; G06T 2207/30256; G06T 2207/10048; G06T 7/2073

(57) ABSTRACT

Methods and systems for operating a lane sensing system for a vehicle having at least one side-mounted infrared light source are disclosed. One system includes an ambient light sensor configured to detect a light level condition of an environment surrounding the vehicle; an infrared light sensor configured to detect an infrared light reflection from a lane marker; and a controller in communication with the ambient light sensor, the infrared light source, and the infrared light sensor, the controller configured to receive sensor data corresponding to the light level condition, determine if the light level condition is below a threshold, command the infrared light source to illuminate if the light level condition is below the threshold, receive infrared reflection data from the infrared light sensor of infrared light reflected from at least one lane marker, and detect a lane boundary based on the infrared reflection data.

### INTRODUCTION

The present invention relates generally to the field of vehicles and, more specifically, to methods and systems for adaptive on-demand lane detection using infrared lighting.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Accurate lane sensing in all light conditions is used by autonomous driving systems. Additionally, accurate lane sensing can be used to notify a driver of possible drift over a lane marker boundary to prompt the user to take corrective action. However, in some driving conditions, such as when the vehicle passes through a tunnel or under an overpass, detection of lane marker boundaries using visible light may be insufficient to accurately detect the vehicle's position with respect to the lane marker boundaries.

### SUMMARY

Embodiments according to the present disclosure provide a number of advantages. For example, embodiments according to the present disclosure enable detection of lane boundary markings in low light level conditions, such as when a vehicle passes through a tunnel or under an overpass or during operation at night. Embodiments according to the present disclosure may thus provide more robust lane detection and detection accuracy while being non-intrusive to the operator and to other vehicles.

In one aspect, a method of operating a lane sensing system for a vehicle is disclosed. The method includes the steps of providing the vehicle with at least one infrared light sensor, at least one infrared light source, at least one vehicle sensor configured to measure an ambient light level, and a controller in communication with the at least one infrared light source, the at least one infrared light sensor, and the at least one vehicle sensor; receiving sensor data corresponding to the ambient light level of an environment of the vehicle; determining, by the controller, if the ambient light level is below an ambient light threshold; calculating, by the controller, an infrared intensity level based on the ambient light level, if the ambient light level is below the ambient light threshold; commanding, by the controller, the at least one infrared light source to turn on at the calculated infrared intensity level, if the ambient light level is below the ambient light threshold; receiving, by the controller, infrared reflection data from at least one infrared light sensor of infrared light from the at least one infrared light source reflected from at least one lane marker; and detecting, by the controller, a lane boundary based on the infrared reflection data from the infrared light reflected from the at least one lane marker.

In some aspects, the method further includes predicting, by the controller, whether the vehicle will pass within a low light area. In some aspects, predicting whether the vehicle will pass within the low light area includes receiving, by the controller, map data corresponding to a vehicle location and determining, by the controller, whether the map data indicates that a projected path of the vehicle will pass within the low light area. In some aspects, the method further includes commanding, by the controller, the at least one infrared light source to turn on if the map data indicates that the projected path of the vehicle will pass within the low light area. In some aspects, the infrared intensity level is a predetermined intensity level.

In another aspect, an automotive vehicle includes a vehicle body; a mirror coupled to a side of the vehicle body, the mirror including a housing, an infrared light source, and an infrared sensor; an ambient light sensor; and a controller in communication with the infrared light source, the infrared sensor, and the ambient light sensor. The controller is configured to receive sensor data from the ambient light sensor corresponding to an ambient light level of an environment of the vehicle; determine if the ambient light level is below an ambient light threshold; calculate an infrared intensity level based on the ambient light level, if the ambient light level is below the ambient light threshold; command the at least one infrared light source to turn on at the calculated infrared intensity level, if the ambient light level is below the ambient light threshold; receive infrared reflection data from at least one infrared light sensor of infrared light from the at least one infrared light source reflected from at least one lane marker; and detect a lane boundary based on the infrared reflection data from the infrared light reflected from the at least one lane marker.

In some aspects, the infrared intensity level is a predetermined intensity level. In some aspects, the ambient light sensor is an optical camera. In some aspects, the controller is further configured to predict whether the vehicle will pass within a low light area. In some aspects, predicting whether the vehicle will pass within the low light area includes receiving map data corresponding to a vehicle location and determining whether the map data indicates that a projected path of the vehicle will pass within the low light area. In some aspects the controller is further configured to command the at least one infrared light source to turn on if the map data indicates that the projected path of the vehicle will pass within the low light area.

In yet another aspect, a system for operating a lane sensing system for a vehicle having at least one side-mounted infrared light source is disclosed. The system includes an ambient light sensor configured to detect an ambient light level condition of an environment surrounding the vehicle; an infrared light sensor configured to detect an infrared light reflection from a lane marker; and a controller in communication with the ambient light sensor, the infrared light source, and the infrared light sensor, the controller configured to receive sensor data corresponding to the ambient light level condition, determine if the ambient light level condition is below a threshold, command the infrared light source to illuminate if the light level condition is below the threshold, receive infrared reflection data from the infrared light sensor of infrared light reflected from at least one lane marker, and detect a lane boundary based on the infrared reflection data.

In some aspects, the controller is further configured to calculate an infrared intensity level based on the ambient light level condition, if the ambient light level condition is below the threshold. In some aspects, the infrared intensity level is a predetermined intensity level. In some aspects, the ambient light sensor is an optical camera. In some aspects, controller is further configured to predict whether the vehicle will pass within a low light area. In some aspects, predicting whether the vehicle will pass within the low light area includes receiving map data corresponding to a vehicle location and determining whether the map data indicates that a projected path of the vehicle will pass within the low light area.

### BRIEF DESCRIPTION OF THE DRAWINGS

The present disclosure will be described in conjunction with the following figures, wherein like numerals denote like elements.

FIG. 1 is a schematic diagram of a vehicle having at least one infrared light source, according to an embodiment.

FIG. 2 is a schematic diagram of a side-mounted rear view mirror of a vehicle, such as the vehicle of FIG. 1, illustrating a downward-facing infrared light source mounted to the rear view mirror, according to an embodiment.

FIG. 3 is a schematic diagram of a vehicle, such as the vehicle of FIG. 1, illustrating an infrared illumination area, according to an embodiment.

FIG. 4 is a schematic block diagram of a lane sensing system for a vehicle, such as the vehicle of FIG. 1, according to an embodiment.

FIG. 5 is a flow chart of a method to detect lane boundaries using on-demand, adaptive infrared lighting, according to an embodiment.

FIG. 6 is a flow chart of a method to detect lane boundaries using on-demand, adaptive infrared lighting, according to another embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

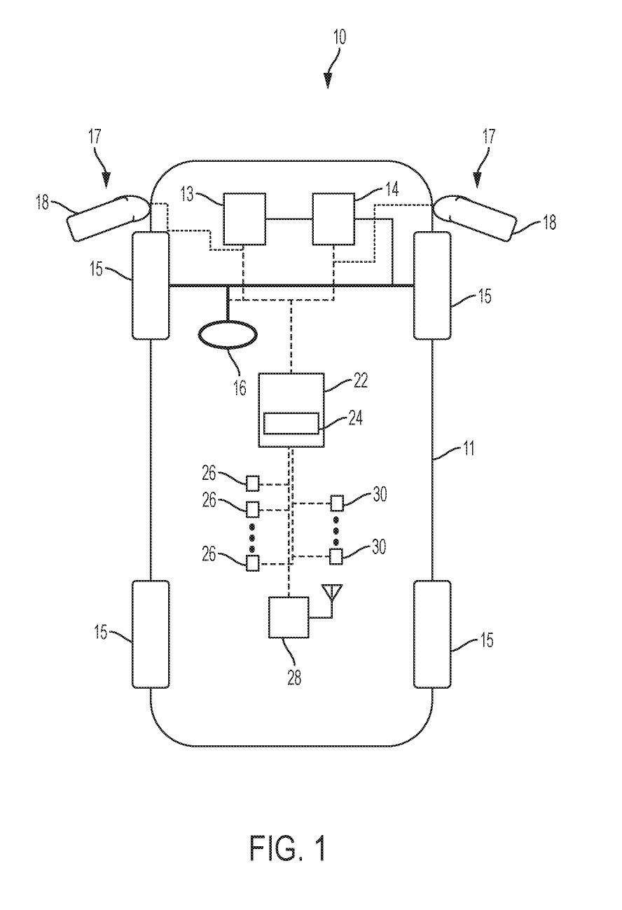

FIG. 1 schematically illustrates an automotive vehicle 10 according to the present disclosure. The vehicle 10 generally includes a body 11 and wheels 15. The body 11 encloses the other components of the vehicle 10. The wheels 15 are each rotationally coupled to the body 11 near a respective corner of the body 11. The vehicle 10 further includes side-mounted rear view mirrors 17 coupled to the body 11. Each of the side-mounted rear view mirrors or mirrors 17 includes a housing 18. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems. The vehicle 10 additionally includes a steering system 16. While depicted as including a steering wheel and steering column for illustrative purposes, in some embodiments, the steering system 16 may not include a steering wheel.

In various embodiments, the vehicle 10 also includes a navigation system 28 configured to provide location information in the form of GPS coordinates (longitude, latitude, and altitude/elevation) to a controller 22. In some embodiments, the navigation system 28 may be a Global Navigation Satellite System (GNSS) configured to communicate with global navigation satellites to provide autonomous geo-spatial positioning of the vehicle 10. In the illustrated embodiment, the navigation system 28 includes an antenna electrically connected to a receiver.

With further reference to FIG. 1, the vehicle 10 also includes a plurality of sensors 26 configured to measure and capture data on one or more vehicle characteristics, including but not limited to vehicle speed, vehicle heading, and ambient light level conditions. In the illustrated embodiment, the sensors 26 include, but are not limited to, an accelerometer, a speed sensor, a heading sensor, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, the vehicle 10 also includes a plurality of actuators 30 configured to receive control commands to control steering, shifting, throttle, braking or other aspects of the vehicle 10.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

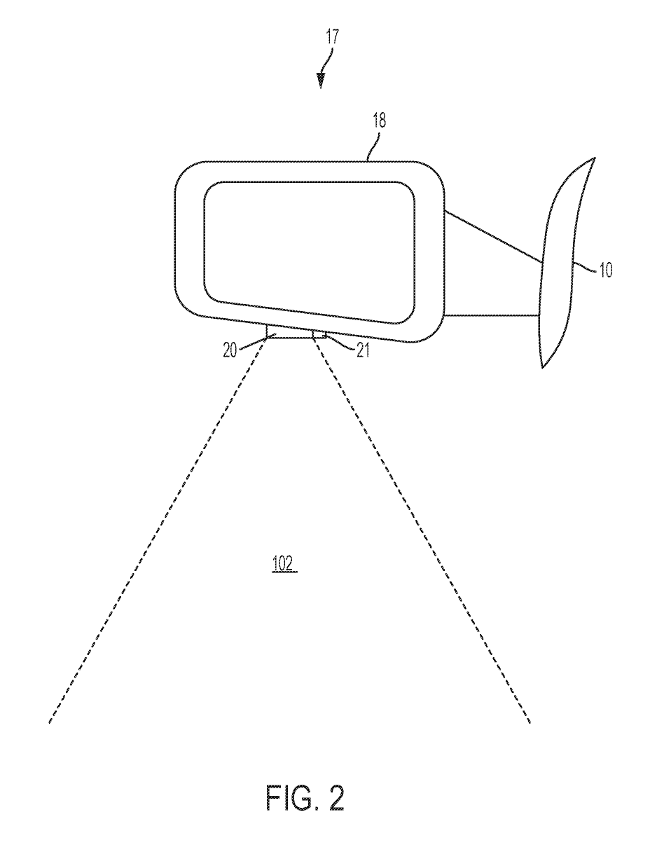

As illustrated in FIG. 2, the vehicle 10 also includes an infrared light source 20. In some embodiments, such as the embodiment shown in FIG. 2, the infrared light source 20 may be coupled to the housing 18 of the side-mounted rear view mirror 17 using any type of mechanical connector or fastener. In some embodiments, the infrared light source 20 is coupled to the housing 18 during a molding process. The infrared light source 20 emits infrared light that illuminates a cone-shaped area 102. In some embodiments, an infrared light sensor or infrared camera 21, one of the sensors 26, is mounted near the infrared light source 20. The infrared light sensor 21 detects infrared light reflected from lane boundary markings and enables detection of the lane boundary markings in low light level conditions. In some embodiments, the infrared light sensor 21 is unitarily formed with the infrared light source 20. In some embodiments, the infrared light sensor 21 is separate from the infrared light source 20.

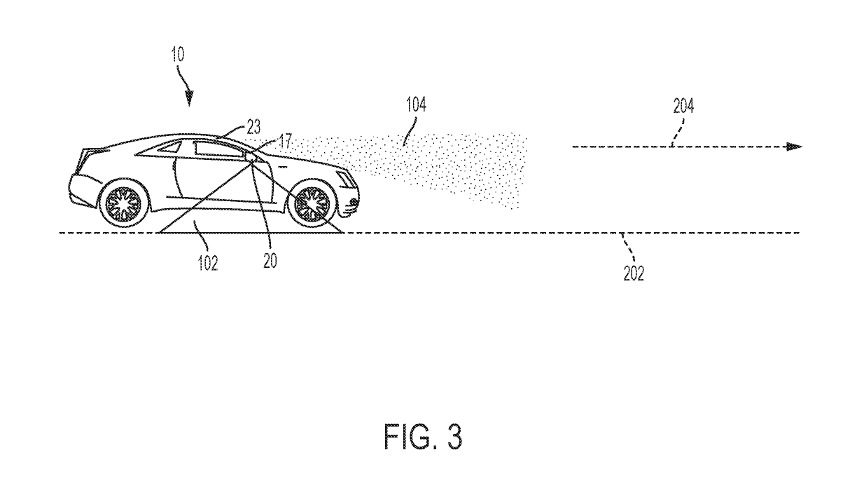

FIG. 3 schematically illustrates the vehicle 10 traveling along a road in a direction of travel 204. The road has lane marker boundaries 202. The vehicle 10 is equipped with a front camera 23, one of the sensors 26. As shown, a front camera 23 is positioned on the roof of the vehicle 10 facing the front of the vehicle 10 in the direction of travel 204. The front camera 23 provides images of an area 104 ahead of the vehicle 10 and also provides information on the lighting condition of the environment surrounding the vehicle 10. Additionally, the front camera 23 provides information on the environment ahead of the vehicle 10 along the predicted path of travel. This information includes, for example and without limitation, an upcoming tunnel or overpass or other low light condition area. Furthermore, the front camera 23 provides information on the ambient light condition of the environment of the vehicle 10. As discussed in greater detail below, as the vehicle 10 approaches and enters the low light area, the front camera 23 captures images illustrating the lighting condition. The images are processed by the controller 22 to detect the lighting condition. The controller 22 processes the lighting condition information, calculates a desired infrared intensity level, and commands illumination from an infrared light source, such as the infrared light source 20 mounted on the mirror 17. The infrared light from the infrared light source 20 illuminates the area 102 that includes the lane boundary markers 202 indicating a lane of travel on a road, such as lane marker lines. The infrared light is reflected from the lane markers and is received by the infrared light sensor 21, shown in FIG. 2. The reflected light is processed by the controller 22 to determine if the vehicle 10 is maintaining travel within the lane markers or if the vehicle 10 has drifted to the left or right over the lane markers.

If, after processing the reflected light information, the controller 22 determines that the vehicle 10 has departed from the lane of travel by, for example, loss of detection of the lane markers, the controller 22 can trigger notification systems that notify the vehicle operator of the lane departure. These notification methods include, without limitation, visual, audible, tactile, or any other type of warning signal. While the front camera 23 is shown in FIG. 3 as mounted on the roof of the vehicle 10, the front camera 23 could be mounted anywhere on the vehicle 10 that provides a view forward of the vehicle 10 along the predicted path of travel or images that provide information on the ambient light condition. Additionally, while the infrared light source 20 is shown as mounted underneath the side-mounted rear view mirror 17, the infrared light source 20 could be mounted anywhere on the vehicle 10 at a position to illuminate the lane markers.

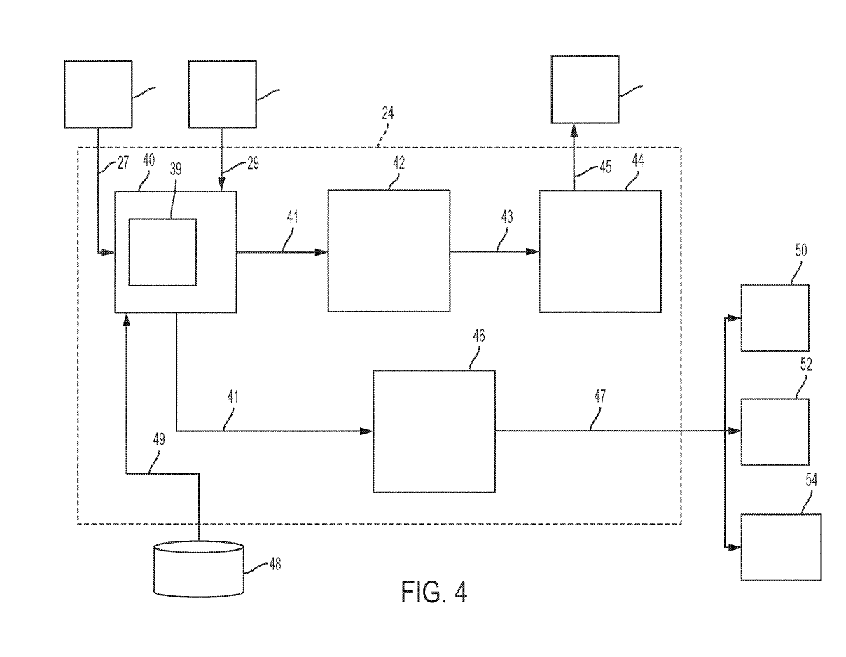

With reference to FIG. 4, the controller 22 includes an infrared-based lane sensing system 24 for illuminating lane markers using infrared light during low light conditions and detecting the lane markers using infrared light reflection from the markers. In an exemplary embodiment, the infrared-based lane sensing system 24 is configured to receive map data corresponding to a vehicle location and/or sensor data corresponding to an ambient light level condition of the environment of the vehicle 10, determine whether the vehicle 10 is passing through a low light area or whether the projected path of travel of the vehicle 10 will be through a low light area, command illumination from an infrared light source at a predetermined or calculated intensity level, receive infrared reflection data, and detect a lane boundary based on the infrared light reflection data. Additionally, the controller 22 can generate an output indicating the lane detection determination that may be used by other vehicle systems, such as an automated driving assistance system (ADAS), a user notification system, and/or a lane keeping/monitoring system.

The lane sensing system 24 includes a sensor fusion module 40 for receiving input on vehicle characteristics, such as a vehicle speed, vehicle heading, an ambient light level condition of the environment of the vehicle 10, or other characteristics. The sensor fusion module 40 is configured to receive input 27 from the plurality of sensors, such as the sensors 26 illustrated in FIG. 1, including the front camera 23 and the infrared light sensor 21. In some embodiments, the sensor fusion module 40 contains a video processing module 39 configured to process image data from the sensors 26, such as the data received from the front camera 23 and the infrared light sensor 21. Additionally, the sensor fusion module 40 is also configured to receive navigation data 29 including longitude, latitude, and elevation information (e.g., GPS coordinates) from the navigation system 28. The sensor fusion module is also configured to receive map data 49 from a map database stored on a storage medium 48. The map data 49 includes, but is not limited to, road type and road condition data, including tunnels, overpasses, etc. along a predicted path of travel of the vehicle 10.

The sensor fusion module 40 processes and synthesizes the inputs from the variety of sensors 26, the navigation system 28, and the map database 48 and generates a sensor fusion output 41. The sensor fusion output 41 includes various calculated parameters including, but not limited to, an ambient light level condition of the environment through which the vehicle 10 is passing, a projected path of the vehicle 10, and a current location of the vehicle 10 relative to the projected path. In some embodiments, the sensor fusion output 41 also includes parameters that indicate or predict whether the vehicle 10 will be passing through an area having a low light level, such as a tunnel or under a highway overpass.

The lane sensing system 24 also includes an intensity calculation module 42 for calculating a desired intensity of the infrared light source 20. The intensity of the infrared light source 20 depends on the ambient light level determined by the sensor fusion module 40 based on the input from the sensors 26, including the front camera 23. The intensity calculation module 42 processes and synthesizes the sensor fusion output 41 and generates a calculated intensity output 43. The calculated intensity output 43 includes various calculated parameters including, but not limited to, a calculated intensity level of the infrared light to be emitted by the infrared light source 20.

With continued reference to FIG. 4, the lane sensing system 24 includes a control module 44 for controlling the infrared light source 20. The control module 44 receives the calculated intensity output 43 and generates a control output 45 that includes various parameters, including but not limited to a control signal to command the infrared light source 20 to emit infrared light at the calculated intensity level. In some embodiments, the intensity level is calculated by the intensity calculation module 42 based on the ambient light level condition detected by the sensors 26, including the front camera 23. In some embodiments, the intensity level is a predetermined value.

The lane sensing system 24 includes a lane boundary detection module 46 for detecting a lane boundary based on infrared light reflection from the lane boundary markers. The lane boundary detection module 46 processes and synthesizes the sensor fusion output 41 that includes data from the sensors 26, including the infrared sensor 21, and generates a detection output 47. The detection output 47 includes various calculated parameters including, but not limited to, a position of the vehicle 10 with respect to the lane boundary markers (e.g., over the lane boundary to the left, over the lane boundary to the right, or between the lane boundary markers). The position of the vehicle 10 with respect to the lane markers is based on the reflection of infrared light from the lane makers received by the infrared sensor 21. The detection output 47 is received, in some embodiments, by an automated driving assistance system (ADAS) 50, a lane keeping or lane monitoring system 52, and/or a user notification system 54.

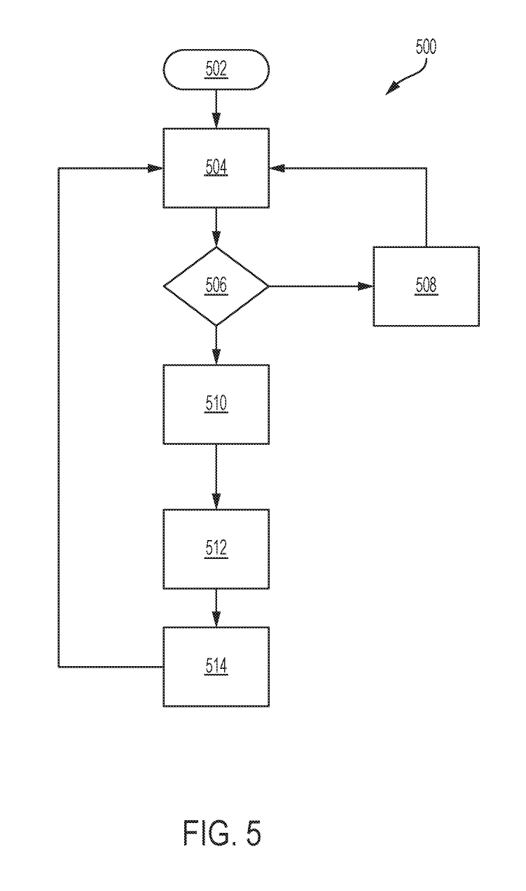

As discussed above, various parameters, including the location of the vehicle 10 with respect to upcoming, known low light areas as indicated by the navigation system 28, the map data 49, and the light level condition as detected by the sensors 26, are used to determine when to use infrared light to illuminate the lane markers. FIG. 5 is a flow chart of a method 500 illustrating the determination of when to turn on an infrared light source 20 based on navigation and map data of the projected path of the vehicle. The navigation data is obtained from the navigation system 28 and the map data is obtained from one or more map databases 48 associated with the controller 22. The method 500 can be utilized in connection with the vehicle 10, the controller 22, and the various modules of the lane sensing system 24, in accordance with exemplary embodiments. The order of operation of the method 500 is not limited to the sequential execution as illustrated in FIG. 5, but may be performed in one or more varying orders as applicable and in accordance with the present disclosure.

As shown in FIG. 5, starting at 502, the method 500 proceeds to step 504. At 504, the sensor fusion module 40 of the lane sensing system 24 receives navigation data 29 and map data 49. Together, the navigation data 29 and the map data 49 provide information on the location of the vehicle 10, the projected path of the vehicle 10 along a roadway, and upcoming low light level areas along the projected path of the vehicle 10. These low light level areas include tunnels, highway overpasses, bridges, etc.

Next, at 506, based on the map data and the navigation data, a determination is made regarding whether the projected path of the vehicle 10 includes a low light level area. A low light level area is defined as an area where visible light is insufficient to illuminate the lane markers to accurately sense the lane markers and monitor the path of the vehicle 10 between the lane markers and the vehicle 10 will be subject to the low light level condition for a predetermined low light level time and/or a low light level distance. In a low light level area, the light level is below a predetermined threshold. In some embodiments, the predetermined light level threshold is between approximately 0.5 and 2 lux. In some embodiments, the predetermined light level threshold is approximately 0.5 lux, approximately 1.0 lux, approximately 1.5 lux, or approximately 2.0 lux. In some embodiments, the predetermined light level threshold is between approximately 0.25 lux and approximately 2.5 lux. In some embodiments, the low light level time is between approximately 0.3 and 0.5 seconds. In some embodiments, the low light level distance is between approximately 10 and 20 meters.

If the data indicates that the vehicle 10 is not or will not, within a predetermined time or distance, enter a low light level area, the method 500 proceeds to 508. If the vehicle 10 includes an ADAS system, such as the ADAS 50, the ADAS 50 can determine a configurable length of predetermined “look ahead distance” along the path of travel of the vehicle 10. In some embodiments, the predetermined look ahead distance is between approximately 300 to 3,000 meters. In some embodiments, the predetermined look ahead distance is approximately 500 meters, approximately 1,000 meters, approximately 1,500 meters, approximately 2,000 meters, or approximately 2,500 meters. In some embodiments, the predetermined look ahead distance is independent of vehicle speed. In some embodiments, the predetermined time is approximately 5 seconds. In some embodiments, the predetermined time is between approximately 3 and 10 seconds, between 3 and 8 seconds, or between 4 and 6 seconds. In some embodiments, the predetermined time is approximately 5 seconds, approximately 8 seconds, approximately 10 seconds, or approximately 15 seconds.

At 508, the infrared light 20 is not commanded to illuminate and detection of the lane marker boundaries is sufficient with visible light and visible light sensors. The method 500 returns to 504 and the method proceeds as discussed below.

If, at 506, the navigation and map data indicates that the vehicle 10 is currently traveling through a low light level area or will enter a low light level area within the predetermined time or distance as discussed above, the method 500 proceeds to 510. At 510, the control module 44 generates the control signal 45 to turn on the infrared light source 20. The infrared light source 20 may be turned on at a predetermined intensity level or the intensity level may be determined by the intensity calculation module 42 based on the expected low light level area along the projected path of the vehicle 10. For example, and without limitation, if the projected path of the vehicle 10 includes a tunnel, the control module 44 generates the control signal 45 to command the infrared light source 20 to turn on at a first intensity level. If the projected path of the vehicle 10 includes an overpass, the control module 44 generates the control signal 45 to command the infrared light source 20 to turn on at a second intensity level that is less than the first intensity level since the ambient light level is expected to be higher when the vehicle passes under an overpass than when the vehicle 10 passes through a tunnel. In some embodiments, the infrared lights source 20 is commanded to emit infrared light with intensity levels equivalent to between approximately 1 to 3 lux for visible light. In some embodiments, the first intensity level is between approximately 0.5 lux and 2 lux. In some embodiments, the second intensity level is between approximately 1 lux and 3 lux.

The method 500 proceeds to 512. At 512 the sensor fusion module 40 receives sensor data from the sensors 26, including the infrared sensor 21. The sensor data includes reflection data from the infrared light emitted by the infrared light source 20, reflected off of the lane markers, and received by the infrared sensor 21. Next, at 514, the lane boundary detection module 46 detects whether the vehicle 10 has maintained position in the lane by analyzing the sensor data 41. The analysis includes determining if the reflections of the lane markers are detected on both sides of the vehicle 10, or if the vehicle 10 has passed over the left or right side lane boundaries. The output from the lane boundary detection module 46 may be transmitted to other vehicle systems, for example and without limitation, the ADAS 50, the lane keeping system 52, and the user notification system 54 shown in FIG. 2. The method 500 returns to 504 and the method 500 continues as discussed above.

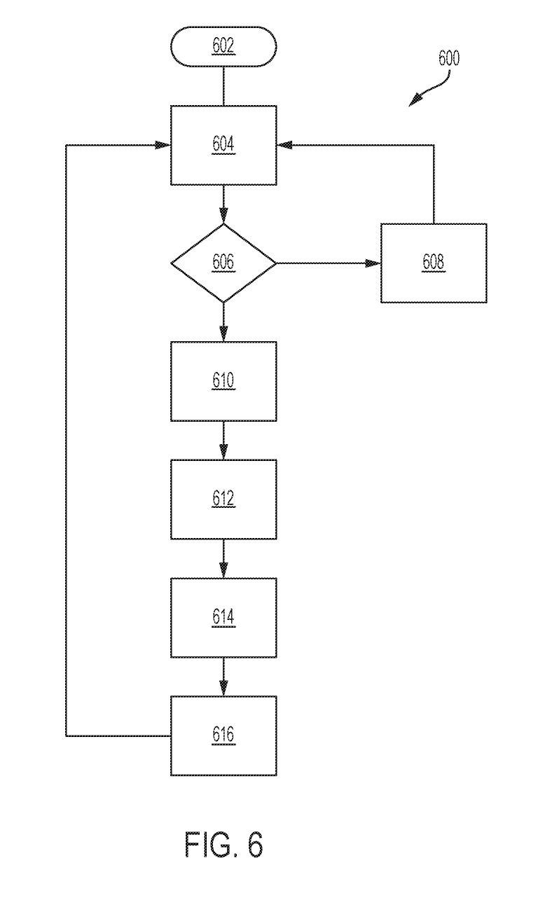

FIG. 6 is a flow chart of a method 600 illustrating the determination of when to turn on an infrared light source 20 based on the detected ambient light level condition. The light level condition is determined from sensor data 27 obtained by the sensors 26, including the front camera 23, that is processed and analyzed by the sensor fusion module 40 of the controller 22. The method 600 can be utilized in connection with the vehicle 10, the controller 22, and the various modules of the lane sensing system 24, in accordance with exemplary embodiments. The order of operation of the method 600 is not limited to the sequential execution as illustrated in FIG. 6, but may be performed in one or more varying orders as applicable and in accordance with the present disclosure.

As shown in FIG. 6, starting at 602, the method 600 proceeds to step 604. At 604, the sensor fusion module 40 of the lane sensing system 24 receives sensor data 27 from the sensors 26, including the front camera 23. The sensor data 27 is analyzed and processed by the sensor fusion module 40, including the video processing module 39, to determine an ambient light level condition.

Next, at 606, based on the sensor data 27, a determination is made regarding whether the vehicle 10 is traveling through a low light area. The determination of whether the vehicle 10 is passing through a low light area is based on a comparison of the ambient light level detected by the sensors 26, including the front camera 23, to a predetermined threshold value. As discussed above, the threshold value is between approximately 0.5 and 2.0 lux. In some embodiments, the predetermined light level threshold is approximately 0.5 lux, approximately 1.0 lux, approximately 1.5 lux, or approximately 2.0 lux. In some embodiments, the predetermined light level threshold is between approximately 0.25 lux and approximately 2.5 lux. If the detected light level is below the predetermined threshold, the sensor data indicates that the vehicle 10 is traveling through a low light area. If the data indicates that the vehicle 10 is not passing through a low light level area, that is, the detected light level is above the predetermined threshold light level, the method 600 proceeds to 608. At 608, the infrared light 20 is not commanded to illuminate and detection of the lane markers is sufficient with visible light and visible light sensors. The method 600 returns to 604 and the method proceeds as discussed below.

If, at 606, the data indicates that the vehicle 10 is currently traveling through a low light level area, the method 600 proceeds to 610. At 610, the intensity calculation module 42 calculates a desired infrared lighting or intensity level based on the detected ambient light level. For example, and without limitation, when the vehicle 10 travels through a tunnel, the ambient light level will be lower than when the vehicle 10 passes under an overpass. Thus, the desired intensity level of the infrared light source 20 is calculated to be a higher value when the vehicle 10 travels through a tunnel than when the vehicle 10 passes under an overpass. In some embodiments, the desired intensity level is equivalent to approximately 1 to 3 lux for visible light.

Next, at 612, the control module 44 generates the control signal 45 to turn on the infrared light source 20 at the calculated intensity level. The method 600 proceeds to 614. At 614, the sensor fusion module 40 receives sensor data from the sensors 26, including the infrared sensor 21. The sensor data includes reflection data from the infrared light emitted by the infrared light source 20 reflected off of the lane boundary markers and received by the infrared sensor 21. Next, at 616, the lane boundary detection module 46 detects whether the vehicle 10 has maintained its position in the lane. The analysis includes determining if the reflections of the lane markers are detected on both sides of the vehicle 10, or if the vehicle 10 has passed over the left or right side lane boundaries. The output from the lane boundary detection module 46 may be transmitted to other vehicle systems, for example and without limitation, the ADAS 50, the lane keeping system 52, and the user notification system 54 shown in FIG. 2. The method 600 returns to 604 and the method 600 continues as discussed above.

The methods 500 and 600 are discussed separately, however, in some embodiments, for vehicles equipped with navigation systems and optical sensors, the methods 500 and 600 could operate concurrently. When the methods 500 and 600 operate concurrently, the information on upcoming low light level areas determined at 504 in method 500 and the results of the ambient light level detection made at 604 in method 600 are compared and either the information analyzed at 504 or the results determined at 604 or the information obtained at both 504 and 604 are used to determine whether to illuminate the infrared light source 20. For example and without limitation, if the information on upcoming low light level areas analyzed at 504 indicates an upcoming low light level area but the results of the ambient light level detection made at 604 do not indicate a low light level condition, the infrared light source 20 the infrared light source is commanded to illuminate as discussed above with respect to method 500. Conversely, if the results of the ambient light level detection made at 604 indicate the vehicle is in or approaching a low light level are but the information on upcoming low light level areas determined at 504 does not indicate an upcoming low light level area, the infrared light source 20 is commanded to illuminate as discussed above with respect to method 600.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a.” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3.” “about 2 to about 4” and “about 3 to about 5,” “1 to 3.” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of operating a lane sensing system for a vehicle, the method comprising:
providing the vehicle with at least one infrared light sensor, at least one infrared light source, at least one vehicle sensor configured to measure an ambient light level, and a controller in communication with the at least one infrared light source, the at least one infrared light sensor, and the at least one vehicle sensor;
receiving sensor data corresponding to the ambient light level of an environment of the vehicle;
determining, by the controller, if the ambient light level is below an ambient light threshold;
calculating, by the controller, an infrared intensity level based on the ambient light level, if the ambient light level is below the ambient light threshold;
commanding, by the controller, the at least one infrared light source to turn on at the calculated infrared intensity level, if the ambient light level is below the ambient light threshold;
receiving, by the controller, infrared reflection data from at least one infrared light sensor of infrared light from the at least one infrared light source reflected from at least one lane marker; and
detecting, by the controller, a lane boundary based on the infrared reflection data from the infrared light reflected from the at least one lane marker.

2. The method of claim 1, further comprising predicting, by the controller, whether the vehicle will pass within a low light area.

3. The method of claim 2, wherein predicting whether the vehicle will pass within the low light area comprises receiving, by the controller, map data corresponding to a vehicle location and determining, by the controller, whether the map data indicates that a projected path of the vehicle will pass within the low light area.

4. The method of claim 3, further comprising commanding, by the controller, the at least one infrared light source to turn on if the map data indicates that the projected path of the vehicle will pass within the low light area.

5. The method of claim 1, wherein the infrared intensity level is a predetermined intensity level.

6. An automotive vehicle, comprising:
a vehicle body;
a mirror coupled to a side of the vehicle body, the mirror including a housing, an infrared light source, and an infrared sensor;
an ambient light sensor; and
a controller in communication with the infrared light source, the infrared sensor, and the ambient light sensor, the controller configured to
receive sensor data from the ambient light sensor corresponding to an ambient light level of an environment of the vehicle;
determine if the ambient light level is below an ambient light threshold;
calculate an infrared intensity level based on the ambient light level, if the ambient light level is below the ambient light threshold;
command the at least one infrared light source to turn on at the calculated infrared intensity level, if the ambient light level is below the ambient light threshold;
receive infrared reflection data from at least one infrared light sensor of infrared light from the at least one infrared light source reflected from at least one lane marker; and
detect a lane boundary based on the infrared reflection data from the infrared light reflected from the at least one lane marker.

7. The automotive vehicle of claim 6, wherein the infrared intensity level is a predetermined intensity level.

8. The automotive vehicle of claim 6, wherein the ambient light sensor is an optical camera.

9. The automotive vehicle of claim 6, wherein the controller is further configured to predict whether the vehicle will pass within a low light area.

10. The automotive vehicle of claim 9, wherein predicting whether the vehicle will pass within the low light area comprises receiving map data corresponding to a vehicle location and determining whether the map data indicates that a projected path of the vehicle will pass within the low light area.

11. The automotive vehicle of claim 10, wherein the controller is further configured to command the at least one infrared light source to turn on if the map data indicates that the projected path of the vehicle will pass within the low light area.

12. A system for operating a lane sensing system for a vehicle having at least one side-mounted infrared light source, comprising:
an ambient light sensor configured to detect an ambient light level condition of an environment surrounding the vehicle;
an infrared light sensor configured to detect an infrared light reflection from a lane marker; and
a controller in communication with the ambient light sensor, the infrared light source, and the infrared light sensor, the controller configured to receive sensor data corresponding to the ambient light level condition, determine if the ambient light level condition is below a threshold, command the infrared light source to illuminate if the light level condition is below the threshold, receive infrared reflection data from the infrared light sensor of infrared light reflected from at least one lane marker, and detect a lane boundary based on the infrared reflection data.

13. The system of claim 12, wherein the controller is further configured to calculate an infrared intensity level based on the ambient light level condition, if the ambient light level condition is below the threshold.

14. The system of claim 13, wherein the infrared intensity level is a predetermined intensity level.

15. The system of claim 12, wherein the ambient light sensor is an optical camera.

16. The system of claim 12, wherein the controller is further configured to predict whether the vehicle will pass within a low light area.

17. The system of claim 16, wherein predicting whether the vehicle will pass within the low light area comprises receiving map data corresponding to a vehicle location and determining whether the map data indicates that a projected path of the vehicle will pass within the low light area.
